(19) United States
(12) Patent Application Publication
(10) Pub. No.: US 2014/0097793 A1
(43) Pub. Date: Apr. 10, 2014

(54) ADJUSTABLE DOCKING STATION WITH A SWAPPABLE CHARGING COMPONENT AND A METHOD FOR ITS USE

(71) Applicants: David Wurtz, Boulder, CO (US); Michael Weinstein, Boulder, CO (US)

(72) Inventors: David Wurtz, Boulder, CO (US); Michael Weinstein, Boulder, CO (US)

(21) Appl. No.: 14/049,540

(22) Filed: Oct. 9, 2013

Related U.S. Application Data
(60) Provisional application No. 61/711,308, filed on Oct. 9, 2012.
(60) Provisional application No. 61/793,000, filed on Mar. 15, 2013.

(51) Int. Cl. H02J 7/00

(52) U.S. Cl. CPC H02J 7/0042
USPC 320/108; 320/107; 248/346.03

(57) ABSTRACT

A docking station is disclosed, including a body, having a channel set in the top of the body and extending from one side to the other, and open at both sides, the channel having a floor that extends from front to back at a downward angle with respect to the horizontal, a back wall, and no front wall, a hole in the floor of the channel, and a charging component that may be placed within a hollow chamber beneath the channel and having a charging pin that extends through the hole into the channel when the body is so placed.

### RELATED APPLICATION DATA

This application claims the benefit of Provisional Application No. 61/711,308 filed on Oct. 9, 2012. This application also claims the benefit of Provisional Application No. 61/793,000 filed on Mar. 15, 2013.

### TECHNICAL FIELD

This invention relates generally to a docking station for a mobile device, and particularly to a docking station suitable for use with a wide variety of mobile devices of different sizes and brands.

### BACKGROUND ART

Portable electronic computing devices, such as smartphones and tablets have revolutionized communication. A person can perform tasks formerly requiring desktop computers wired to Ethernet connections, using a pocket device the size of a pack of cards, can carry around a library of novels in a lightweight tablet, and navigate even strange environments with ease using built-in navigation applications. All of these devices, however, are battery operated, and owing to the limitations to battery size required for portability, must be charged regularly. In addition, many mobile devices can exchange information with computers by synchronizing through their charging ports. A popular product for charging and for synchronizing a mobile device is a docking station, on which the device may be supported as it charges, allowing the user conveniently to access the device display.

Most products currently available, however, fall short of the ideal characteristics of a docking station. Most can accommodate only a handful of the currently extant mobile devices, often restricting their use to a single brand, or even a single product line within a brand. If customer purchases a new mobile device, as the rapid pace of innovation demands, the customer often must discard the old charging docking station and purchase a new one. Perhaps as a result of this, charging docks are often made cheaply, with less than ideal materials, and without many features that would make them more convenient to use.

Therefore, there remains a need for a truly versatile, durable and convenient charging dock.

### SUMMARY OF THE EMBODIMENTS

Disclosed is a docking station, including a body, having a top, an underside, a front end, a back end, and two sides, and a channel set in the top of the body and extending from one side to the other, and open at both sides, the channel having a floor.

In a related embodiment, the body is composed primarily of steel. In an additional related embodiment, the channel floor extends from the front toward the back at a downward angle with respect to the horizontal. In another related embodiment, the channel has a back wall substantially perpendicular to that floor. In still another embodiment, the channel has no front wall. The channel is lined with a soft pad in another embodiment. According to another embodiment, the soft pad has a floor located over the floor of the channel, the floor of the soft pad extending from the front toward the back at a downward angle. The docking station includes a charging component set within the body and having a circuit that inductively charges a mobile device placed in the channel, in another embodiment. In another embodiment, the dock station includes a pin extending from the floor of the channel, and substantially perpendicular to that floor, the pin adapted for insertion in a port in a mobile device. The pin is not electrical in nature, in another embodiment.

In an additional related embodiment, the dock station includes a hole in the floor of the channel, a hollow chamber beneath the channel and communicating with the hole, and a charging component placed within the hollow chamber, and wherein the pin is attached to the charging component and extends through the hole into the channel. According to another embodiment, the charging component has a perforation, the pin is attached to the charging component by threading an electrical cable that terminates in the pin through the perforation, and the charging component is formed to extend the pin that is so attached through the hole in the channel floor. In another embodiment, the charging component is composed of flexible material. According to another embodiment, the charging component is connected to a detachable charging cable adapted to insertion into a power source. The charging component may be detached from the body and interchanged with another charging component having a differently shaped pin, in another embodiment. Under another embodiment, the charging component further comprises a sensor that activates electric circuitry. In an additional embodiment the sensor is taken from a group consisting of a vibration sensor, a capacitance sensor, a noise sensor, an optical sensor, a motion sensor, or an infrared sensor. In another embodiment, the electrical circuitry activates an indicator light. In still another embodiment, a mobile device is attached to the docking station, and the electrical circuitry communicates with the mobile device.

Another embodiment includes means for simultaneously adjusting the height and forward position of the pin. In another embodiment, the docking station has a base upon which the charging component rests when the base is inserted in the body. In another embodiment, the body and base are so formed as to permit the base to fit securely in the body in at least two different orientations relative to the body, each orientation resulting in the base supporting the charging component at a different height within the body when the body, charging component, and base are assembled. According to another embodiment, the body and base are so formed as to permit the base to fit securely in the body in at least two different orientations relative to the body, each orientation resulting in the base supporting the charging component at a forward position within the body when the body, charging component, and base are assembled. In still another embodiment, the body and base are so formed as to permit the base to fit securely in the body in at least two different orientations relative to the body, each orientation resulting in the base supporting the charging component at a different height and forward position within the body when the body, charging component, and base are assembled. In an additional embodiment, the top surface of the charging component and the underside of the chamber in the body are shaped to engage each other when the charging component is located at least at one height as supported by the base, and the base is further shaped to admit the charging component in a niche that positions the charging component so as to engage the top surface of the charging component with the underside of the chamber when the body, charging component, and base are assembled. Under another embodiment, the charging component flanges outward towards its bottom, and the base is further shaped to admit the charging component in at least one niche with walls that angle to grip the flanged portion of the charging component when the body, charging component, and base are assembled.

A method is also included for charging a mobile device. The method involves providing a docking station as described above, having a base, body, and charging component, assembling the base, body, and charging component together, and placing a mobile device on the channel with the pin inserted in a charging port of the mobile device.

A related embodiment of the method also involves disassembling the docking station by separating the body, base and charging component, reassembling the docking station by combining the body and base with a second charging component having a second pin suitable for charging a second mobile device, and placing the second mobile device on the channel with the second pin inserted in a charging port of the second mobile device. An additional embodiment involves disassembling the docking station by separating the body, base and charging component, rotating the base with respect to the body and charging component to change the height of the charging component within the body when the docking station is assembled, and reassembling the docking station by combining the body and charging component with the rotated base.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation at its initial drawing depiction. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1A is a schematic diagram showing one embodiment of the disclosed docking station;

FIG. 1B is a schematic diagram of a side view of an embodiment of the charging component, showing the relationship between the channel and the pin;

FIG. 1C is a schematic diagram showing an inductive charging component;

FIG. 1D is a schematic diagram of the one embodiment of the claimed docking station, in an exploded view;

FIG. 1E is a schematic diagram of an embodiment of the body of the docking station, showing the chamber for admission of the charging component;

FIG. 1F is a schematic diagram showing one embodiment of a soft pad to be inserted in the channel;

FIG. 1G is a schematic diagram showing a top view of one embodiment of the docking station;

FIG. 1H is a schematic diagram showing the insertion of an embodiment of the soft pad into the channel;

FIG. 1I is a schematic diagram showing the placement of a mobile device on an embodiment of the docking station, in which the soft pad is absent from the channel;

FIG. 1J is a schematic diagram showing the placement of a mobile device on an embodiment of the docking station, in which the soft pad is in place on the channel;

FIG. 1K is a schematic diagram showing an underside view of one embodiment of the assembled docking station;

FIG. 1L is a schematic diagram depicting the flexible housing of the pin in one embodiment of the docking station;

FIG. 1M is a schematic diagram showing a mobile device placed in an embodiment of the docking station;

FIG. 2 is a schematic diagram showing an embodiment of the charging component;

FIG. 3A is a schematic diagram showing the elevation of the pin relative to the body in a particular configuration;

FIG. 3B is a schematic diagram showing the elevation of the pin relative to the body in a particular configuration;

FIG. 4A is a schematic diagram showing an exploded view of one embodiment of the docking station including a base;

FIG. 4B is a schematic diagram showing an underside view of one embodiment of an assembled docking station;

FIG. 5A is a schematic diagram portraying one embodiment of the base;

FIG. 5B is a schematic diagram portraying one embodiment of the base;

FIG. 5C is a schematic diagram portraying one embodiment of the charging component having flanges;

FIG. 5D is a schematic diagram of a base niche formed to receive a charging component having flanges;

FIG. 5E is a schematic diagram portraying one embodiment of the charging component;

FIG. 5F is a schematic diagram portraying one embodiment of the charging component, as combined with portions of the base and body;

FIG. 5G is a schematic diagram portraying one embodiment of the charging component, as combined with portions of the base and body;

FIG. 5H is a schematic diagram showing the underside of an embodiment of the body, including a male member;

FIG. 6A is a schematic diagram showing an exploded view of one embodiment of the docking station including a retainer;

FIG. 6B is a schematic diagram showing an embodiment of the base, retainer, and charging component of the docking station combined together;

FIG. 7 is a schematic diagram of one embodiment of the docking station; and

FIG. 7 is a flowchart depicting one embodiment of a method for charging a mobile device.

### DETAILED DESCRIPTION OF SPECIFIC EMBODIMENTS

Embodiments of the disclosed docking station enable a user to charge variously sized and shaped mobile devices with a single product. The charging component and charging pin may be swapped to fit a device's charging port, whether proprietary or standard-shaped. The length of the exposed charging pin may also be adjusted to accommodate various protective cases used with mobile devices. A sturdy and stable body supports even large devices easily, leaving the devices' displays accessible while in the dock. The docking station also can adjust the height and distance from the front of the station of the charging pin, accommodating mobile devices of different thickness, as well as mobile devices that are in protective cases.

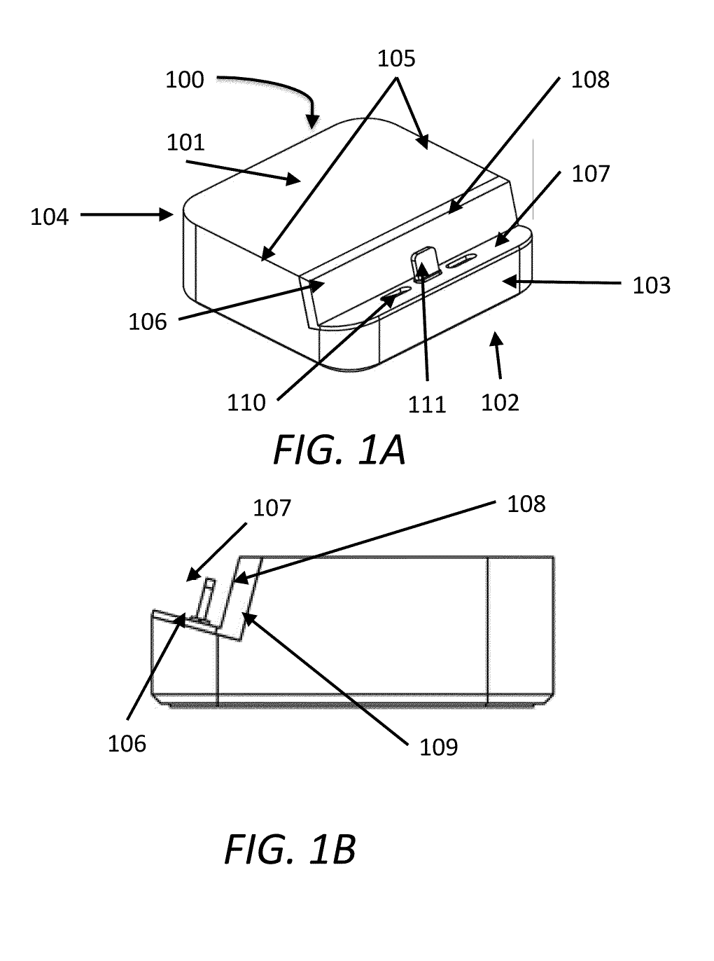

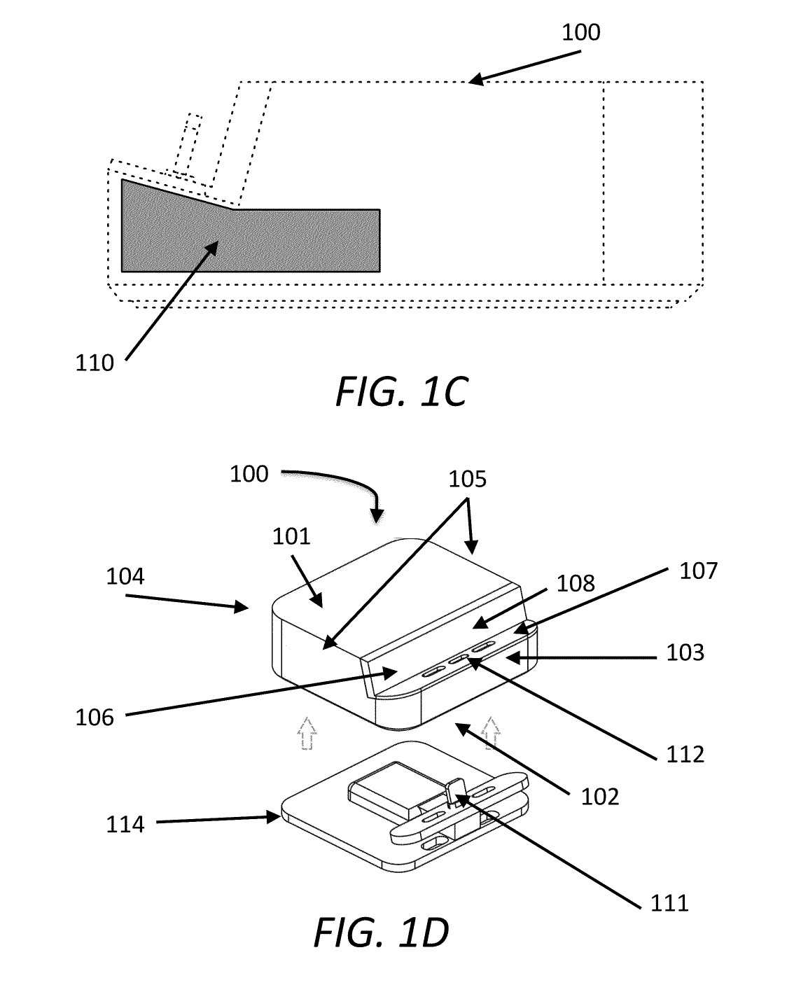

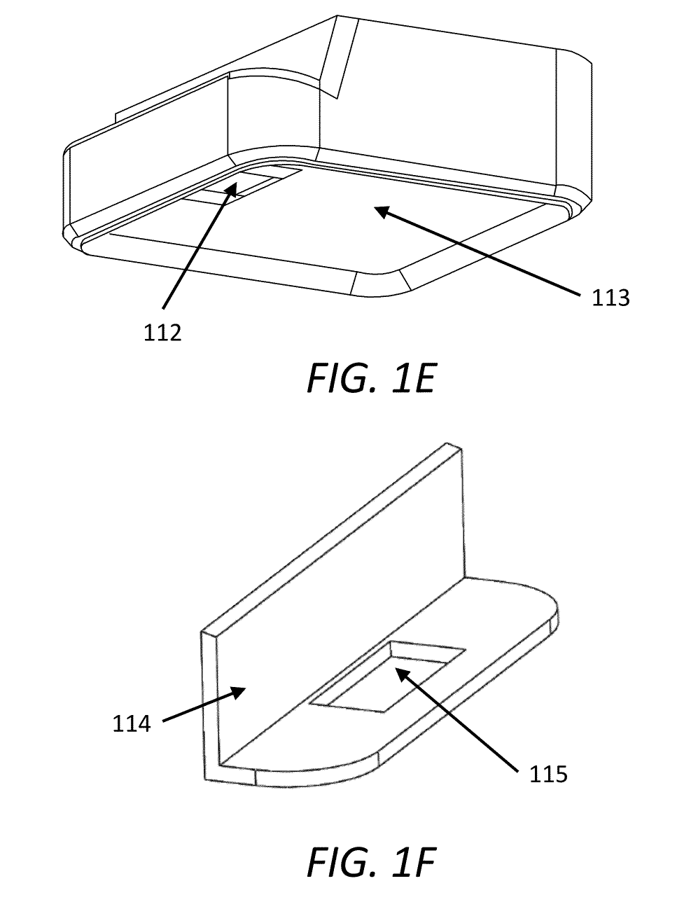

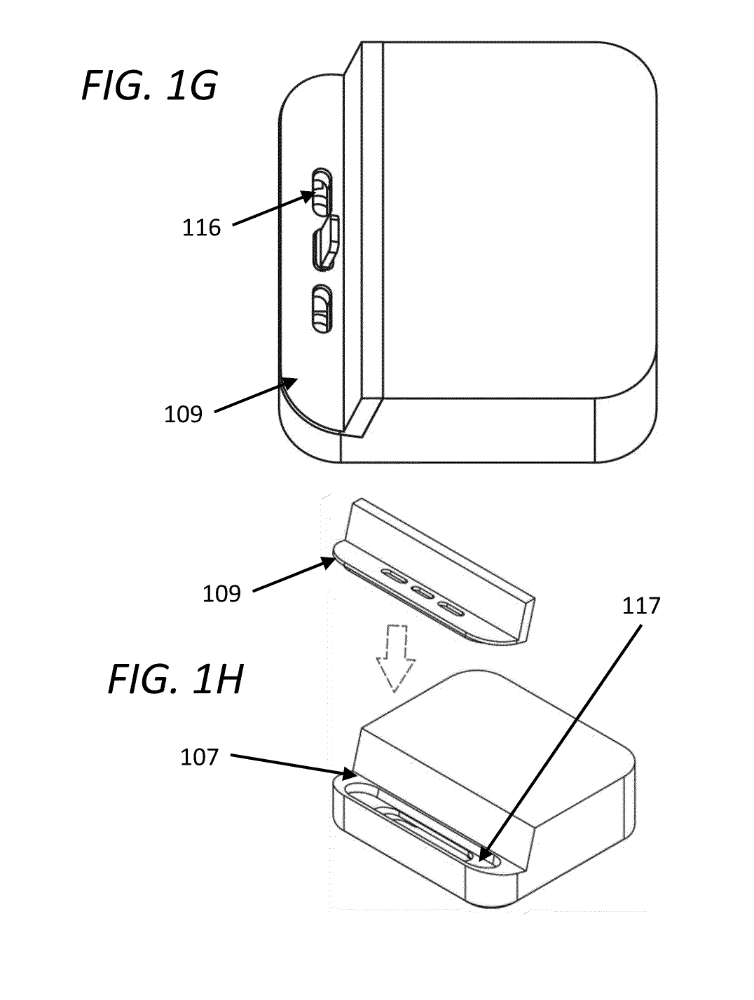

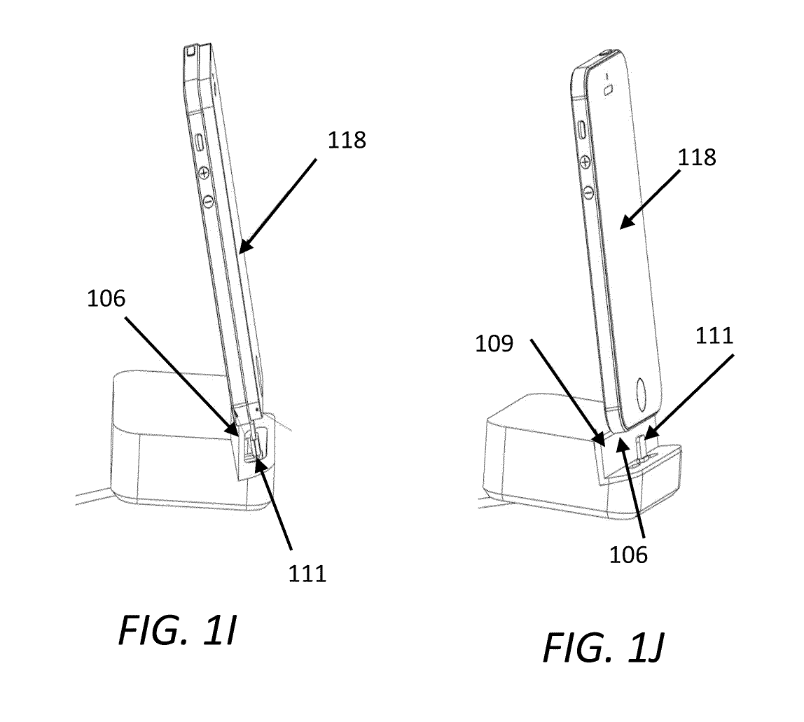

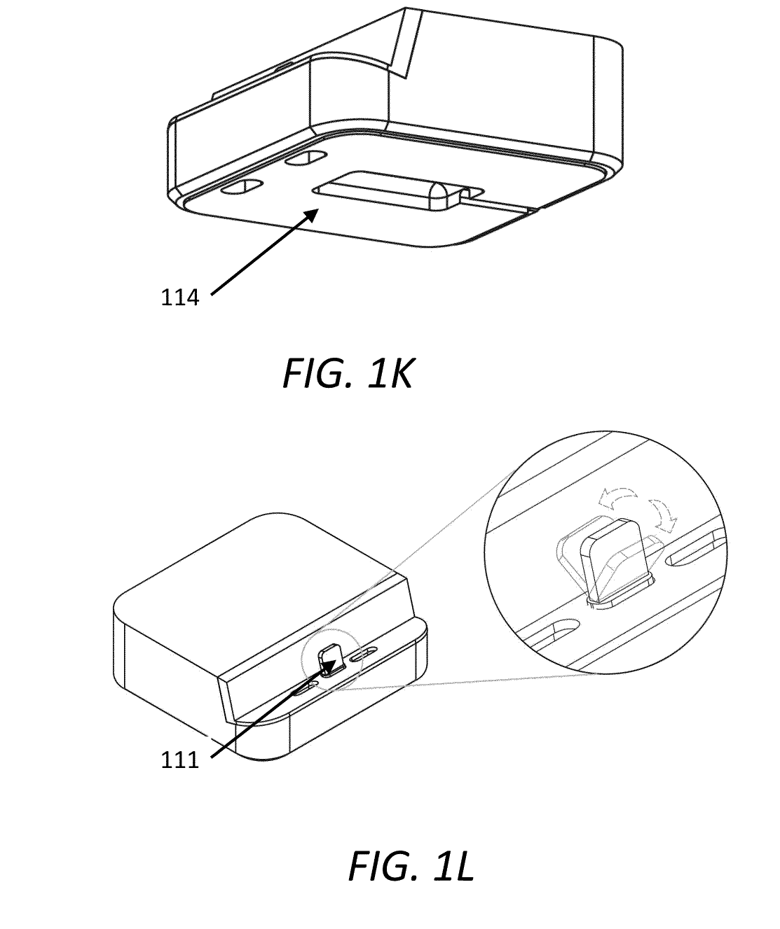

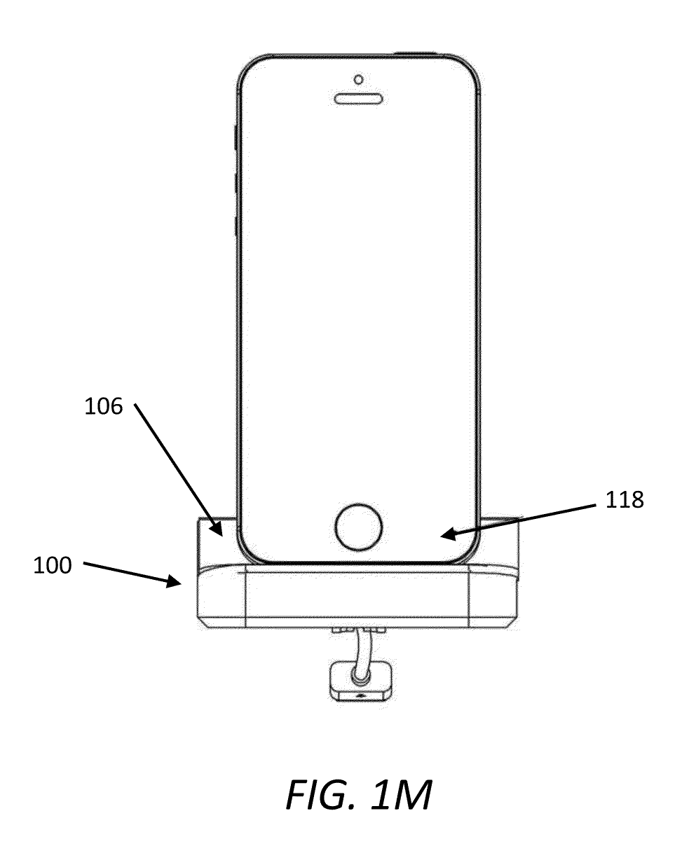

FIG. 1A is a schematic diagram depicting another embodiment of the docking station. The docking station is made up of a body 100, having a top 101, an underside 102, a front end 103, a back end 104, and two sides 105. The docking station also includes a channel 106 set in the top of the body 100 and extending from one side 105 to the other, and open at both sides, the channel 106 having a floor 107.

The body 100 of the docking station may be composed of any material of sufficient strength and rigidity to support the weight of a mobile device. In some embodiments, the body 100 is made of a single material. In some embodiments, the body 100 is composed of a combination of two or more materials. In some embodiments, at least one of the materials making up the body 100 is heavy, to counterbalance the weight of mobile devices placed on the docking station, and to make the docking station less prone to accidental movement. In some embodiments, the body 100 weighs at least one pound. In some embodiments, the body 100 is composed at least partly of metal. In some embodiments, the body 100 is composed at least partly of steel. In one embodiment, the body is composed primarily of steel. For the purposes of this embodiment, “composed primarily of” means that the major structural elements of the body 100 are steel. The body 100 composed primarily of steel may be wholly steel. The body 100 composed primarily of steel may have a coating, such as powder coating or paint, which is not steel. The body 100 composed primarily of steel may have some parts composed of other materials, as long as the body 100 relies upon steel as the principal way to support its weight and that of a mobile device placed in the docking station. In some embodiments, the body 100 is composed at least partly of cobalt. In some embodiments, the body 100 is composed at least partly of tungsten carbide. In some embodiments, the body 100 is composed at least partly of aluminum. In some embodiments, the body 100 is composed at least partly of copper. In some embodiments, the body 100 is coated. The body 100 may be powder-coated. The body 100 may be composed in part of plastic. The body 100 may be composed in part of silicone. The body 100 may be composed in part of glass. The body 100 may be composed in part of fiberglass. Part of the body 100 may be composed of resin. Part of the body 100 may be composed of ceramic. Part of the body 100 may be composed of wood. Part of the body 100 may be composed of polycarbonate. Part of the body 100 may be composed of stone.

The docking station also includes a channel 106 set in the top of the body and extending from one side 106 to the other. The channel 106 functions as a seat to support a mobile device set in the dock. The channel 106 is and open at both sides, enabling it to accommodate variously sized mobile devices. FIG. 1B shows an embodiment of the docking station from a side view, permitting a clear view of the open end of the channel 106. The uninterrupted sides of the channel permit a device wider than the width of the dock to rest in the channel 106. In some embodiments, the channel 106 is located at the front of the body 100. In some embodiments, the channel has a floor 107 that extends in the direction from front 103 to back 104 at a downward angle with respect to the horizontal. Returning to FIG. 1D, in some embodiments, the channel has a back wall 108 substantially perpendicular to that floor. In some embodiments, the channel has no front wall. In some embodiments, the lack of a front wall means that the channel 106 can accommodate a mobile device even if the device is thicker than the width of the channel 106. In some embodiments, the floor of the channel 107 has no lip or other barrier across it whatsoever to the front. This enables mobile devices whose thickness is greater than the width of the channel from front 103 to back 104 to dock on the docking station. The back wall 108 in some embodiments is positioned to allow a mobile device set in the docking station to lean against the back wall 108. In some embodiments, the channel 106 is slide-resistant.

In some embodiments, as shown in FIG. 1B, the channel 106 is lined with a soft pad 109. The soft pad 109, in some embodiments, acts to absorb shock when a mobile device is placed on the docking station. The soft pad 109, in some embodiments, acts to prevent abrasion of the mobile device when placed on the docking station. The soft pad 109 may be composed of an elastomeric material. The soft pad 109 may be rubber. The soft pad 109 may be silicone. The soft pad 109 may be composed of a synthetic polymer. The soft pad 109 may be composed of a textile, such as felt. In some embodiments, the soft pad 109 has a floor located over the floor of the channel, the floor of the soft pad extending from the front toward the back at a downward angle. Thus, for example, where the channel 106 has a level floor, the soft pad 109 can duplicate the angle described above for an angled floor.

In some embodiments, as shown in FIG. 1C the docking station also includes a charging component 110 set within the body and having a circuit that inductively charges a mobile device placed in the channel. A mobile device in some embodiments is any portable electrical device, including without limitation mobile phones, smartphones, tablets, personal digital assistants, music players, and e-book readers.

In some embodiments, the docking station further includes pin 111 set in the floor 107 of the channel 106, and substantially perpendicular to that floor 107, the pin adapted for insertion in a port in a mobile device. In some embodiments, the pin 111 is not electrical in nature, and functions to anchor the mobile device in place; for instance, in embodiments in which the docking station charges mobile devices by induction. The pin 111 in some embodiments is conductive. The pin 111 may fit a universal serial bus (USB) port. The pin 111 may fit a micro-USB port. The pin 111 may fit a mini-USB port. The pin 111 may fit a direct current (DC) jack. The pin 111 may fit a proprietary port system such as Apple Lightning®.

In some embodiments, the pin is mechanically supported by a charging component. FIG. 1D is an exploded view depicting one embodiment of the docking station including a hole 112 in the floor of the channel 107, a hollow chamber (see FIG. 1E, 113) beneath the channel and communicating with the hole 112, and a charging component 114 placed within the hollow chamber (see FIG. 1E, 113), and wherein the pin 111 is attached to the charging component 114 and extends through the hole 112 into the channel 106. The channel floor 107 has a hole 112 in it in some embodiments. The body 100 in some embodiments contains a chamber 113 that communicates with the hole 112 in the channel floor 107. In some embodiments, as shown in FIG. 1E, the chamber 113 is formed by hollowing out the underside 102 of the body 100. The underside of the chamber 113 may be at least partially open forming an aperture that can accept the charging component 114.

In some embodiments, as shown in FIG. 1F, the soft pad 109 may have a hole 115 in it corresponding to the hole 112 in the channel floor 107. In some embodiments, as shown in FIG. 1G, the soft pad 109 may have one or more additional holes 116 to allow objects, light or sound through. In some embodiments, the soft pad 109 may be detached and reattached. FIG. 1H shows a detached soft pad 109 and a depression 117 in the channel floor 107 in which the soft pad 109 can be securely fitted for attachment. In some embodiments, the soft pad 109 may be detached and replaced with a soft pad 109 having a different thickness; the result is that the pin 111 protrudes into the channel 106 to a different extent. A thicker pad will cause the pin 111 to protrude a lesser distance into the channel 106, while a thinner pad will cause the pin 111 to protrude a greater distance into the channel. In some embodiments, the soft pad 109 may be removed entirely, and the channel 106 may be used without the soft pad, to cause the pin 111 to protrude farther into the channel 106. FIG. 1I shows a mobile device 118 with a protective case around it being placed in a channel 106 that has no soft pad; more of the pin 111 is exposed, permitting it to penetrate more deeply, as required by the presence of the case. In FIG. 1J, there is no case on the mobile device 118, and the channel 106 has a soft pad 109 in place, partially covering the pin 111, which does not have to penetrate as deeply without the case around the mobile device 118.

Referring again to FIG. 1D, some embodiments of the docking station also include a charging component 114. The charging component is formed so that it fits within the chamber 113. In some embodiments, the charging component 114 fills substantially the entire chamber 113. In some embodiments, the charging component 114 fills only a portion of the chamber. In some embodiments, where the chamber 113 is formed by hollowing out the underside 102 of the body, the charging component 114 covers the bottom aperture of the chamber 113 so that the body 100 rests on the charging component 114 when the docking station is assembled and in use. FIG. 1K shows the bottom of an embodiment of the charging component 114 that covers the entire aperture. In some embodiments, the bottom of the charging component 114 is composed of a slide-resistant material. The charging component 114 has a pin 111 adapted to insertion into the charging port of a mobile device. The charging component mechanically positions the pin 111 relative to the docking station for insertion into a mobile device placed in the dock. The pin 111 is so placed on the charging component 114 that when the charging component 114 and the body 100 are assembled, the pin 111 extends through the hole 112 in the channel floor 108. In some embodiments, the charging component 114 has a perforation, the pin 111 is attached to the charging component by threading an electrical cable that terminates in the pin 111 through the perforation, and the charging component 114 is formed to extend the pin 111 that is so attached through the hole 112 in the channel floor. Thus, for example, if the user has a charging cable that came with a device, and wishes to use that cable with the docking station, the user can thread the charging cable through the charging component 114, assembling a charging component 114 and pin 111 combination as disclosed above. This combination may then be inserted within the body 100 to assemble the docking station. Where the charging component 114 is elastomeric, the hole through it may be narrow, so that the charging component 114 securely grips the pin 111 on the cable 200 the user inserts into the charging component.

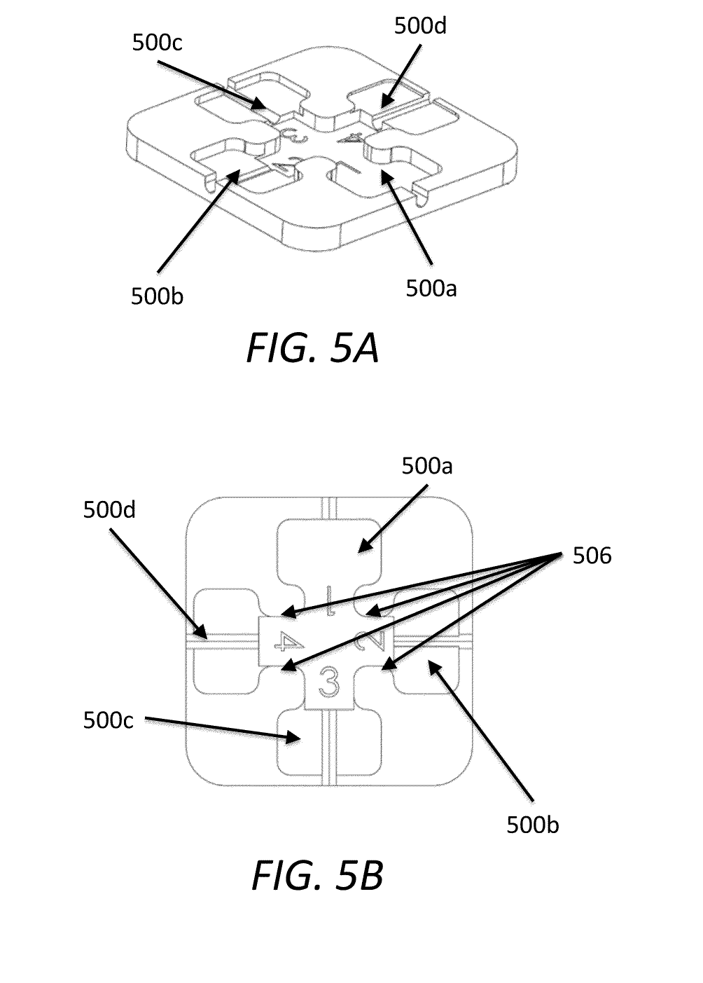

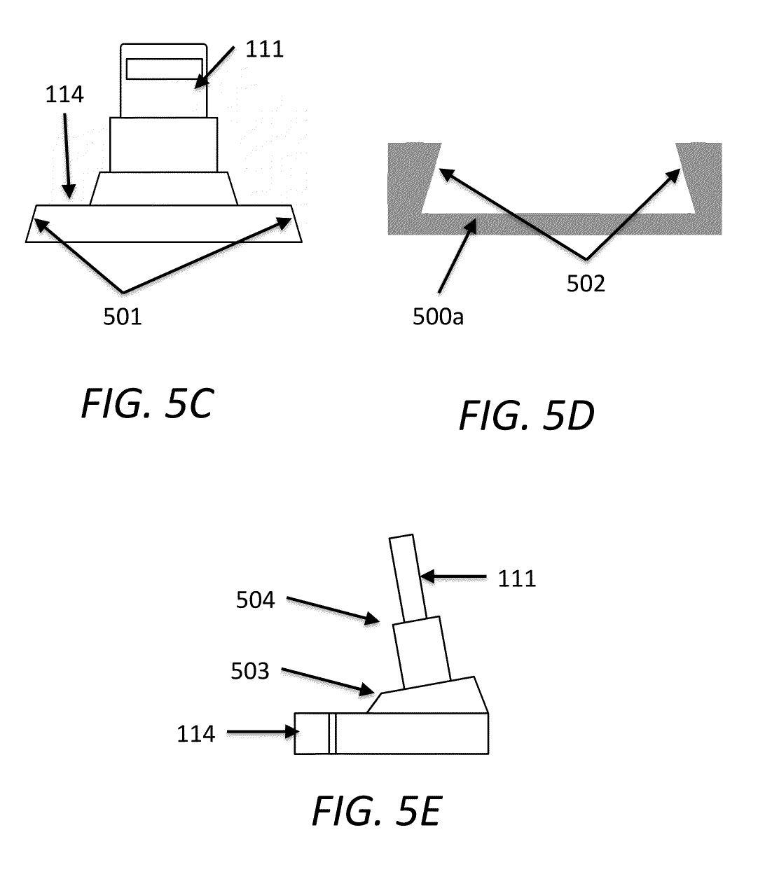

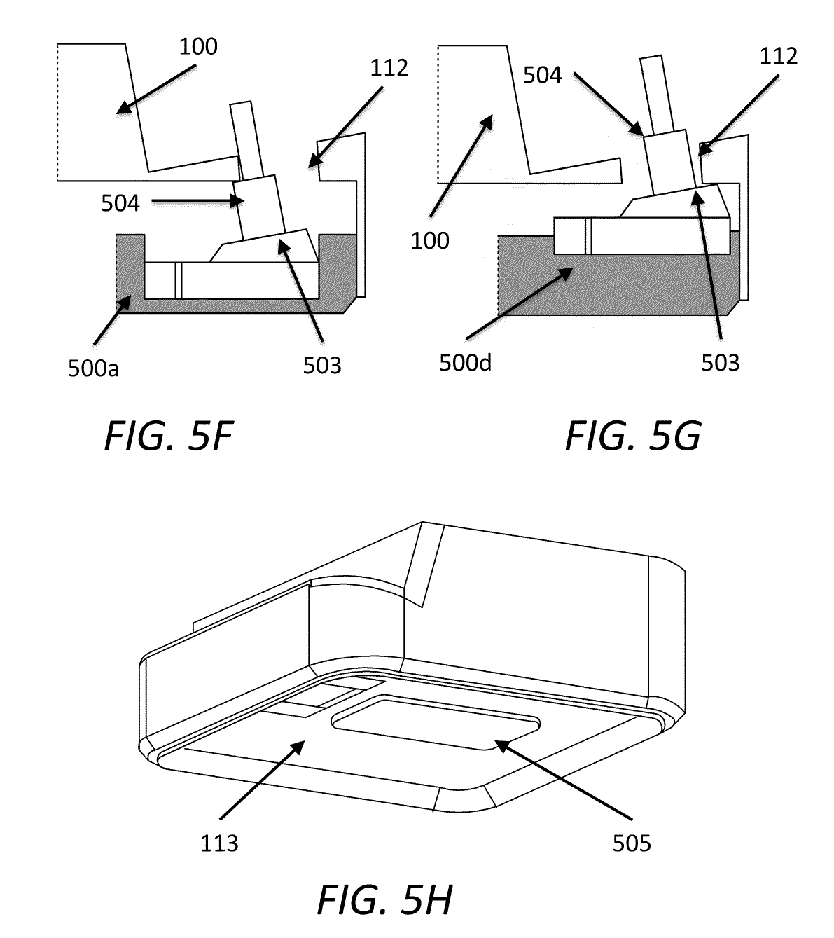

The charging component may be constructed of any material known in the art as long as it permits the conduction of electricity to the pin 111 while electrically insulating the conducting portion from the rest of the docking station; for example, the charging component 114 may be composed of a dielectric material with a wire embedded in it and connected to the pin 111. Alternatively, the charging component 114 need not have electrical insulating properties if the conducting element connected to the pin 111 is coated in an insulator, as an electrical wire is commonly coated in plastic. In some embodiments, the charging component 114 passes electrical power bidirectionally between an attached mobile device 118 and an external source, such as a wall power adapter, computer or computer monitor (not shown), via the pin 111. In some embodiments, the charging component 114 passes data bidirectionally between an attached mobile device 118 and an external source, such as a wall power adapter, computer or computer monitor (not shown), via the pin 111. The material of which the charging component is composed may be any of the materials listed above for the body 100. Alternatively, in some embodiments the charging component 114 is composed of flexible material. In some embodiments, the flexible charging component 114 allows the pin to be moved slightly back and forth and side-to-side in the hole 112 when the docking station is assembled, as further illustrated by FIG. 1L; this makes it easier to insert and remove a mobile device without damaging the device or the pin 111. The durometer of the flexible material and the shape of the charging component may each affect the degree of flexibility afforded the movement of the charging pin 111; the manufacturer may adjust the properties of the material accordingly when creating the charging component 114. In some embodiments, the charging component 114 has wings (see FIG. 5C, 501) or similar body forms to aid in the flexibility of the pin 111. The flexible material may be a synthetic elastomeric material. The flexible material may be a natural elastomeric material. The flexible material may be a plastic. The flexible material may be rubber. The flexible material may be silicone. The flexible material may be resin. The charging component may be designed to fit securely to the base, so that it may be attached and removed without the use of fasteners or tools.

FIG. 1M is a front view of the assembled dock, with a mobile device 118 resting in the channel 106 on top of the body 100, and with the pin (not shown) inserted in its charging port. The display of the mobile device 118 is entirely exposed, and thus accessible for operation. In some embodiments, the portion of the docking station upon which the docking station rests when assembled is slide-resistant.

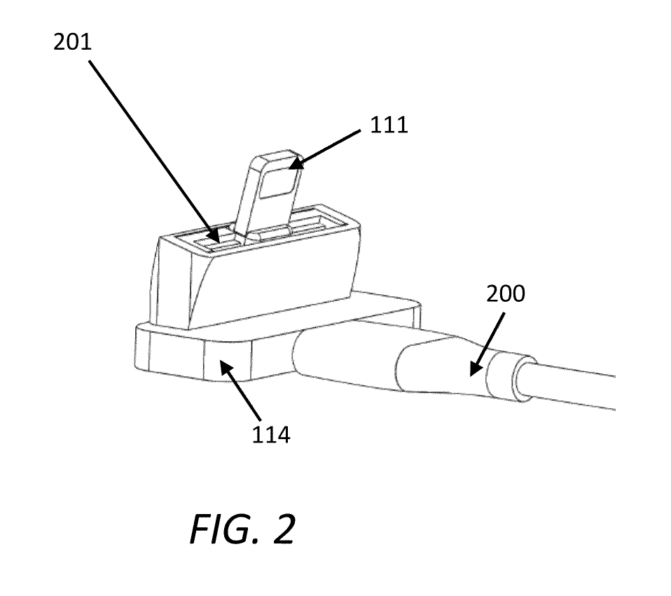

In some embodiments, as shown in FIG. 2, the charging component 114 is connected to a charging cable 200 adapted to insertion into a power source. The charging cable 200 is electrically connected via the charging component 114 to the pin 111 such that the connection of the charging cable 200 to a power source will cause a mobile device connected via its charging port to the pin 111 to charge. The power source may be an electrical outlet in a building, such as a two or three-pronged alternating current outlet. The power source may be an outlet on a vehicle. The power source may be a car “cigarette-lighter” port. The power source may be a generator. The power source may be a battery. The power source may be a solar cell. The charging cable 200 may also be adapted to enable the bidirectional exchange of data between the charging component 114 and an external power source (not shown) via the charging cable 200. The charging cable 200 may be detachable from the charging component. The term “detachable” as used herein means detachable and re-attachable. The charging cable 200 may connect to the charging component 114 by any port known in the art. The charging cable 200 may be fused to the charging component 110; for instance, the charging cable 200 may connect to the pin 111 by electrically connecting the charging cable wire directly to the pin. The charging cable 200 may alternatively be soldered to the conducting element within the charging component 114. In some embodiments, the charging component may be detached from the charging cable. For instance, the charging cable 200 may connect to the charging component 114 by way of a charging port set in the charging component 114. The cable 200 may connect to the component 114 via a universal serial bus (USB) connection. The cable 200 may connect to the component 114 via a micro-USB port. The cable 200 may connect via a mini-USB port. The cable 200 may connect via a direct current (DC) jack. The connection between the charging component 114 and the charging cable 200 may use a proprietary port system such as Apple Lightning®. In some embodiments, the cable 200 is provided by the manufacturer of the docking station. In some embodiments, the cable 200 is a cable not provided by the manufacturer, but fits the port for connecting the cable 200 to the charging component 114.

In some embodiments, the charging component 114 may be detached from the body 100 and interchanged with another charging component having a differently shaped pin. For instance, if the user was previously using the docking station to charge an iPhone®, and purchased a Samsung® tablet with a distinct charging port, the charging component 114 with a pin 111 suitable for charging the iPhone® could be replaced with a charging component 114 having a pin 111 suitable for the tablet. Where the charging cable 200 may be detached from the charging component 114, as described above, the same charging cable 200 may be used with the new charging component 114. In some embodiments, the pin may be detached from the charging component and replaced with a different pin. For instance, if the user was previously using the docking station to charge an iPhone®, and purchased a Samsung® tablet with a distinct charging port, the pin 111 suitable for charging the iPhone® could be replaced with a pin 111 suitable for the tablet.

In some embodiments, the charging component 114 contains additional electronics. For instance, the charging component may have at least one element 201 positioned on the charging component to input or output signals. The at least one element may be positioned so as to be accessible through a hole 116 in the soft pad 109 as described above with respect to FIG. 1G. In some embodiments, the at least one element 201 is a sensor that activates electric circuitry. The at least one element 201 may include a thermometer. The at least one element 201 may include a motion sensor; for example, the motion sensor may be adaptable to detect the placement of a mobile device on the docking station. The at least one element 201 may include an optical sensor. The at least one element 201 may include a touch sensor (not shown). The touch sensor may be proprioceptive. The touch sensor may sense changes in capacitance. The at least one element 201 may include a vibration sensor. The at least one element 201 may include a sound sensor. In some embodiments, the sensor is taken from a group consisting of a vibration sensor, a capacitance sensor, a noise sensor, an optical sensor, a motion sensor, or an infrared sensor. The electrical circuitry activates an indicator light in some embodiments; for instance, the indicator light could aid a user in locating the docking station in the dark. In other embodiments, a mobile device is attached to the docking station, and the electrical circuitry communicates with the mobile device. The electrical circuitry may convey data to the mobile device. The electrical circuitry may cause the display of the mobile device to display a message. The electrical circuitry may cause the display of the mobile device to display the time. The electrical circuitry may cause the display of the mobile device to display meteorological data. In some embodiments, the electrical circuitry activates other elements of the mobile device; for example, it may cause the mobile device to vibrate. It may cause the mobile device to emit sound through its audio output devices. The at least one element 201 may include a speaker. The at least one element 201 may include an indicator light, such as a light-emitting diode. The at least one element 201 may be a port. In some embodiments the port 201 allows the charging component to exchange data. In some embodiments, the port 201 is an audio output jack.

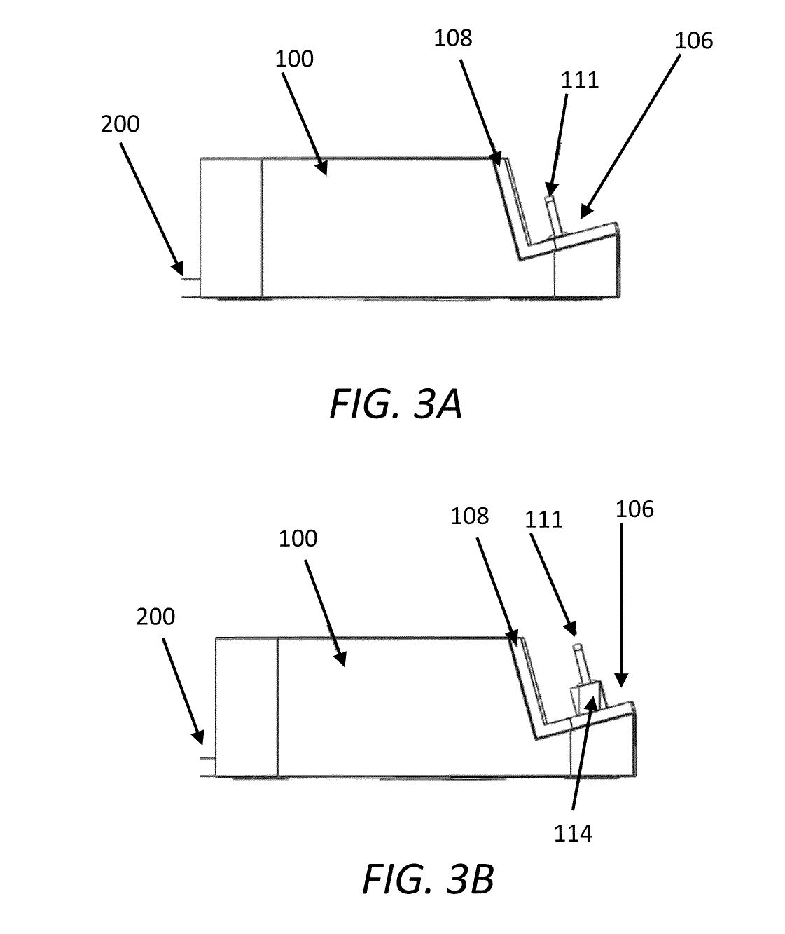

Some embodiments of the docking station also include means for adjusting the height of the pin 111. Some embodiments of the docking station also include means for adjusting the forward position, defined as the distance from the front 103 of the body 100 of the pin 111. Some embodiments of the docking station include means for simultaneously adjusting the height and forward position of the pin 111. FIGS. 3A-B provide a schematic side view of the docking station with the height of the charging pin 111 adjusted vertically in height and forward position simultaneously. In FIG. 3A, the pin 111 is lower and closer to the back wall 108 of the channel. In FIG. 3B, the pin 111 is higher and farther from the back wall 108 of the channel. In some embodiments, the chamber 113 is formed to direct the charging component 114 in a direction of adjustment. In some embodiments, the chamber 113 is a tunnel along which the charging component 114 may be slid. In some embodiments, the chamber 113 is a vertical tunnel, within which the charging component 114 may be slid to adjust its height, providing means for adjusting the height of the pin 111 by adjusting the height of the charging component 114. In other embodiments, the chamber 113 is a horizontal tunnel, along which the charging component 114 may be slid to adjust its forward position, providing means for adjusting the forward position of the pin 111 by adjusting the height of the charging component 114. In additional embodiments, the chamber 113 is an angled tunnel, so that when the charging component 114 slides along the tunnel, its vertical and forward positions simultaneously change, providing means for simultaneously adjusting the height and forward position of the pin 111 by adjusting the height and forward position of the charging component 114. Some embodiments further include means for securing the charging component 114 within the tunnel. As a non-limiting example, where the charging component 114 is elastomeric, the charging component 114 and tunnel may be sized so that the charging component 114 must be compressed to fit in the tunnel, and thus exerts a substantial friction-generating force on the tunnel walls. As another example, there may be a series of protrusions into the tunnel that engage with the exterior surface of the charging component 114 to hold it in place.

In some embodiments, the charging component may be moved to a different position within the tunnel by hand. In some embodiments, the docking station includes means to drive the charging component 114 along the tunnel. The means may include a screw, as set forth more fully below. The means may include a member attached to the charging component 114, which may be slid along the tunnel to cause the charging component to slide with it. The member may be accessible to the user via a slot in the body 100 that communicates with the tunnel. The member may be driven by a mechanical device operated by the user; for instance, the member may be driven by a set of gears connected to a hand crank accessible from outside the body 100. The member may be driven by a set of pulleys connected to a hand crank accessible from outside the body 100. The member may be driven by a set of gears connected to an electric motor that may be operated by controls outside the body 100. The member may be driven by a set of pulleys connected to an electric motor that may be operated by controls outside the body 100.

Some embodiments of the docking station include a screw, the operation of which causes the charging component 114 to alter its position within the body 100. The user may be able to manipulate the screw from outside the body 100 by means of any device known in the art to be suitable for applying rotational force to an object. The user may manipulate the screw using a screwdriver. The user may manipulate the screw using a wrench. The user may manipulate the screw using a key that engages the screw. The user may manipulate the screw using a dial attached to the exterior of the body 100. The user may manipulate the screw using a crank attached to the exterior of the body 100. The user may manipulate the screw using an electrical motor that may be controlled from outside the body 100. In some embodiments, where the chamber 113 forms a tunnel as set forth above, the screw drives an object that exerts pressure on the charging component 114, forcing it along the tunnel. In some embodiments, the screw is directly engaged with the charging component 114. In some embodiments, the chamber 113 does not form a tunnel, and the screw controls the direction in which the charging component 114 moves when the screw is manipulated. In some embodiments the screw is vertical, and turning it changes the charging component's 109 height, providing means for adjusting the height of the pin 111 by adjusting the height of the charging component 114. In other embodiments, the screw is horizontal, so that turning it modifies the charging component's 109 forward position, providing means for adjusting the forward position of the pin 111 by adjusting the height of the charging component 114. In additional embodiments, the screw is angled, so that turning it causes the vertical and forward positions of the charging component 114 simultaneously to change, providing means for simultaneously adjusting the height and forward position of the pin 111 by adjusting the height and forward position of the charging component 114. The body 100 may contain means to hold the charging component rotationally steady, so that it does not turn when the screw turns.

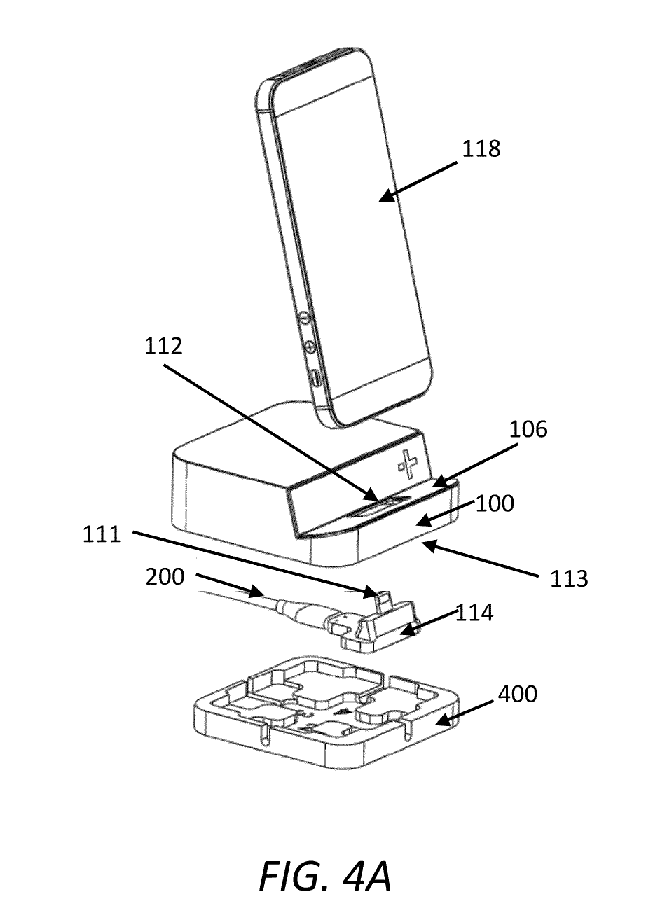

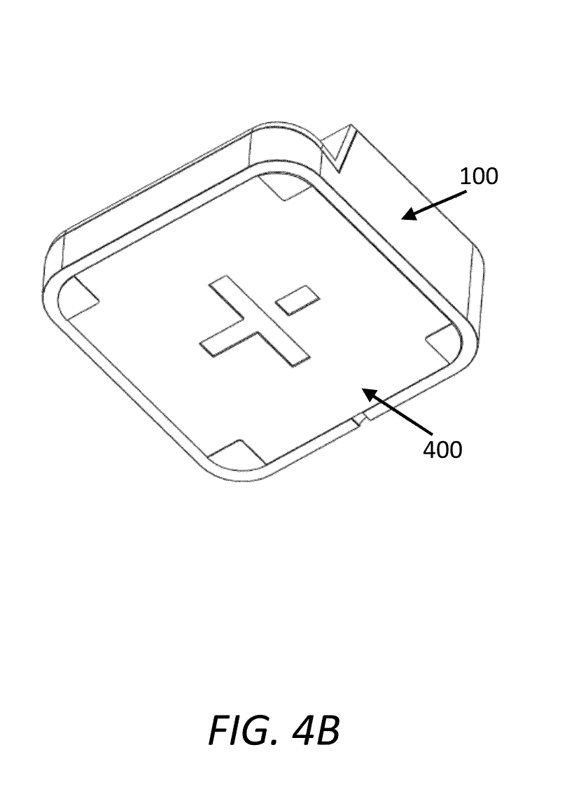

FIG. 4A is an exploded view of another embodiment of the docking station. Included in the embodiment is a base 400 upon which the charging component 114 rests when the base is inserted in the body 100. In some embodiments, the base 400 and body 100 are so formed as to permit the base 400 to fit securely in the body 100 in at least two different orientations relative to the body 100. The base 400 in some embodiments has a perimeter that matches the inner perimeter of the lower aperture of the chamber 113 as shown in FIG. 1E, so that the base fits snugly within the aperture. In some embodiments, fitting snugly within the aperture means a close enough fit for friction between the base and the inner walls of the chamber to support the weight of the base when the assembled docking station is lifted into the air. The base 400 may be formed from any material described above for the body 100 in reference to FIG. 1D. The base 400 may be formed from any material described above for the charging component 114 in reference to FIG. 2. FIG. 4B is a schematic diagram showing the appearance of the assembled docking station in one embodiment as seen from beneath. In some embodiments, parts of the base are flexible, while other parts are more rigid to support the weight of the docking station. The base 400 is a surface on which the docking station rests in some embodiments. The base 400 may be built of a slide-resistant material, as described above in reference to FIGS. 1A-2.

The base 400 may be any shape that can be rotated into at least two distinct orientations and still fit within the body 100. In some embodiments, the base 400 is bilaterally symmetrical, and may be flipped about its axis of symmetry to two positions it which it fits into the body 100. In some embodiments, the base 400 is triangular. In some embodiments, the base 400 is rectangular. In some embodiments, the base 400 may be rotated in the horizontal plane to two or more positions that allow it to fit in the base. For example, a rectangular base 400 may be rotated horizontally to two positions that will permit it to fit within a rectangular aperture, and two more by flipping the base 400 over. An equilaterally triangular base 400 may be rotated horizontally to three positions in which the base can fit in an equilaterally triangular aperture, and three more by flipping the base 400 over. A square base 400 may be rotated to four positions horizontally that fit into a square aperture, and an additional four positions if the base 400 is flipped over. In general, a base with regular polygonal cross-sectional perimeter having n sides may be rotated to 2n distinct positions, n right-side-up and n upside-down, in which that base will fit an equivalently shaped aperture. This holds true if the polygon has rounded vertices or other inclusions or extrusions in its pure geometric form, so long as those inclusions or extrusions are made so as to preserve all the symmetry of all n sides and vertices. Thus, a square base 400 with rounded corners, as depicted in FIG. 4A, may be rotated horizontally to four distinct positions, as long as each corner is rounded in substantially exactly the same way.

In some embodiments, each rotation of the base 400 causes the base 400 to support the charging component 114 at a different height within the body 100 when the base 400, charging component 114, and body 100 are assembled, thus providing means for adjusting the height of the pin 111 by adjusting the height of the charging component 114. As a result, the pin 111 protrudes to a greater or lesser extent through the hole 112 and into the channel 106 depending on the rotation of the base that is chosen when the docking station is assembled. FIG. 5A is a schematic diagram of one embodiment of the base 400, in which the charging component is supported in each rotation of the base 400 by one of four niches 500a-d shaped to hold the charging component. Each niche 500a-d has a different depth. For example, niche 500a has the lowest floor and therefore the greatest depth, while niche 500d has the highest floor, and the shallowest depth. Placing the charging component 114 in the lowest niche 500a thus causes the pin 111 to be located at a lower height relative to the body 100, while placing the charging component 114 in the highest niche 500d causes the pin 111 to be located at a higher height relative to the body 100. In some embodiments, the body 100 and base 400 are so formed as to permit the base 400 to fit securely in the body 100 in at least two different orientations relative to the body 100, each orientation resulting in the base 400 supporting the charging component 114 at a forward position within the body 100 when the body 100, charging component 114, and base 400 are assembled, providing means for adjusting the forward position of the pin 111 by adjusting the height of the charging component 114. For instance, as depicted in FIG. 5B, and by reference to FIG. 4A, the base 400 is further shaped in some embodiments to admit the charging component a different distance from the perimeter of the base 400 in each rotation in which the base 400 is shaped to support the charging component 114. For instance, in a substantially square base 400 each niche 500a-d may be located a different distance from the side of the base nearest to that niche. Niche 500a is farther from its near edge than niche 500d, to give one example. The pin 111 as a result may be farther from the back wall 108 of the channel 106 when in one niche 500d than in another niche 500a; this can allow the docking station to accommodate a thicker mobile device, or one that is in a protective case. In some embodiments, the body 100 and base 400 are so formed as to permit the base 400 to fit securely in the body 100 in at least two different orientations relative to the body 100, each orientation resulting in the base 400 supporting the charging component 114 at a different height and forward position within the body 100 when the body 100, charging component 114, and base 400 are assembled, providing means for simultaneously adjusting the height and forward position of the pin 111 by adjusting the height and forward position of the charging component 114. As shown in FIGS. 5A-B, in some embodiments, each of the niches 500a-d supports the charging component 114 at both a different height and a different forward position; for instance, in position 500a, the charging component 114 is located both lower and further from the front of the body 100 than in position 500d.

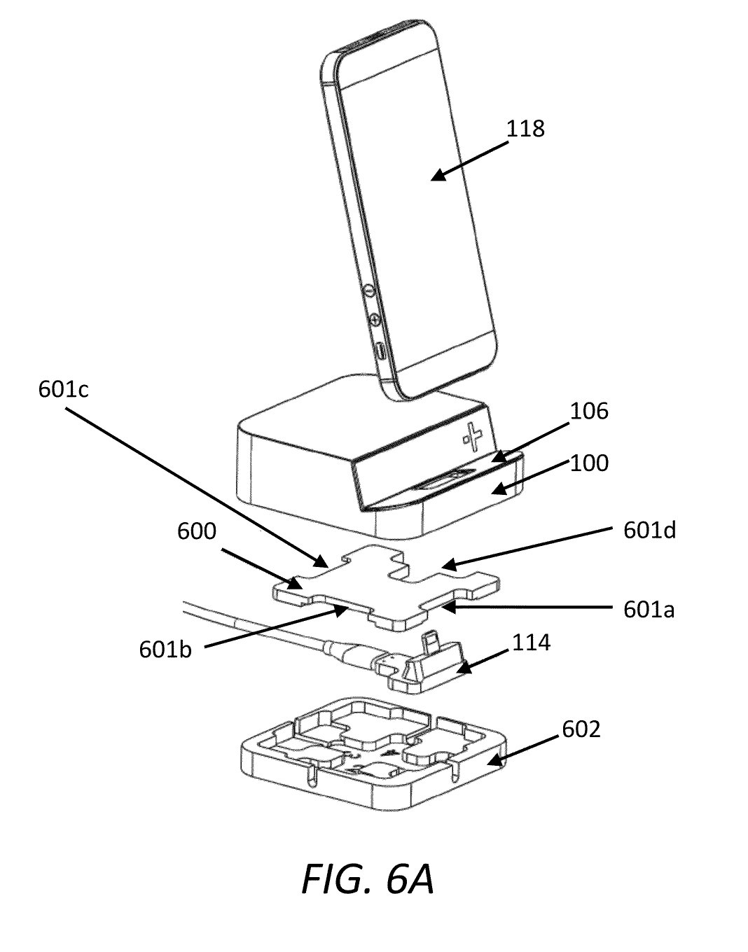

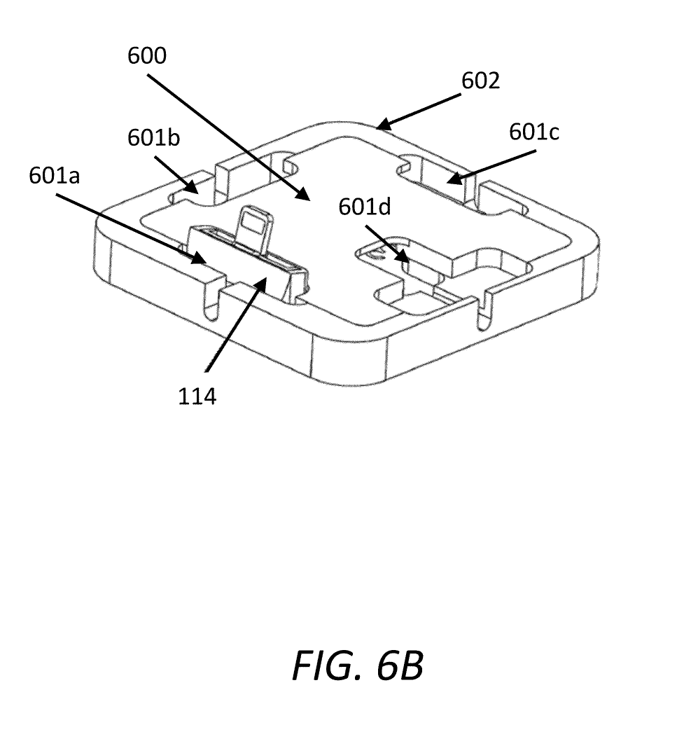

Some embodiments of the docking station include means to secure the charging component 114 within the body 100 so that the charging component 114 does not move when a mobile device is attached to the dock or detached from the dock. In some embodiments, as shown in FIGS. 5C and 5D, the charging component 114 flanges outward towards its bottom 501, and the base 400 is further shaped 502 to admit the charging component in a niche with walls that angle to grip the flanged portion of the charging component 114 when the body 100, charging component 114, and base 400 are assembled. FIG. 5D depicts a niche 502 with walls angled to grip the flanged portion 501 of the charging component 114 depicted in FIG. 5C. In some embodiments, as shown in FIG. 5E, the top surface of the charging component is tiered. The combination of tiers can be arranged to affect the degree to which the pin 111 may be pivoted in the assembled dock. For instance, the first tier 503 above the body of the charging component 114 may be composed of an elastomeric material such as those described above in reference to FIG. 2. The next tier up 504 may be composed of rigid material such as those described above in reference to FIG. 1D. In some embodiments, the top, rigid tier 504 ensures that the pin 111 has sufficient rigidity to insert easily into the charging port of a mobile device. In some embodiments, all tiers are composed of the same material. The first tier 503 may be constructed to be broader to reduce flexibility or narrower to increase flexibility, as desired by the manufacturer. As depicted in FIGS. 5E, 5F, and 5G, in some embodiments the top surface of the charging component 114 and the underside of the chamber 113 in the body are shaped to engage each other when the charging component 114 is located at least at one height as supported by the base 400. As depicted in FIG. 5E-5G, and by reference to FIG. 5A, in some embodiments the top surface of the charging component 114 and the underside of the chamber 113 in the body are shaped to engage each other when the charging component 114 is located at least at one height as supported by the base 400, and the base 400 is further shaped to admit the charging component in a niche 500a-d that positions the charging component so as to engage the top surface of the charging component 114 with the underside of the chamber 113 when the body 100, charging component 114, and base 400 are assembled. For example, as shown in FIG. 5D, when the base is rotated to hold a tiered charging component 114 in a lower position 500a that is also farther from the front of the body 100, the hole 112 may be so positioned that the top tier 504 is in contact with the underside of the chamber just behind the back side of the hole 112, holding the charging component in place. Likewise, as shown in FIG. 5D, when the base is rotated to hold the charging component 114 in a higher position 500d in which the charging component is also closer to the front of the body, the hole 112 may be so positioned that the lower tier 503 is in contact with the underside of the chamber just in front of the hole 112. In some embodiments, the means to hold the charging component 114 in place includes a retainer, as set forth in more detail below with regard to FIGS. 6A-B.

In some embodiments, the base 400 and body 100 have additional features to aid in securing the base 400 in the body 100 without the use of tools or fasteners. Where the base 400 is elastomeric, its size may be large enough relative to the chamber 113 to require the base 400 to be compressed to fit in the chamber; the base 400 will thus exert some recoil force on the inner walls of the chamber 113, thereby increasing the static friction force holding the base 400 in place. In some embodiments, where the body 100 has elastomeric properties, the body 100 must be slightly deformed to accept the base 400, with a similar effect. In some embodiments, as shown in FIG. 5H, the body also includes a male member 505 that extends down into the chamber, and the base 400 is further shaped to grip the male member when the body, charging component, and base are assembled. By way of example, the base in FIG. 5A is formed to grip the rectangular male member depicted in FIG. 5H. Specifically, the portions 506 that form a partial rectangular shape in the center of the base 400 grip the male member 505 when the base 400 is inserted in the chamber 113. In some embodiments, the body 100 has a lip on the inner surface of the chamber 113 to grip the base 400. In some embodiments, the body 400 has a lip on a portion of its outer surface to engage the inner surface of the chamber 113. In some embodiments, the lip on the inner surface of the chamber 113 is placed to engage with a lip on the outer surface of the base 400, causing the base 400 and body 100 to snap together. In some embodiments, an indentation on the outer surface of the base 400 is placed to engage with a lip on the inner surface of the body 100, causing the base 400 and body 100 to snap together. In some embodiments, an indentation on the outer surface of the body 100 is placed to engage with a lip on the inner surface of the base 400, causing the base 400 and body 100 to snap together.

FIG. 6 depicts another embodiment of the dock, which also includes a retainer 600 inserted in the body above the charging component 114 and base 602. The retainer is shaped to fit the top of the charging component 114 and thus hold the charging component 114 firmly in place when the base 602, charging component 114, retainer 600, and body 100 are assembled. The retainer 600 may hold the charging component 114 in place horizontally in the assembled dock, by forming the walls of a niche 500a-d as described above in reference to FIG. 5A. The retainer 600 may also be shaped to fit over a part of the charging component 114 and hold it in place vertically. As a non-limiting example, the retainer 600 in FIG. 6A has four inclusions 600a-d, each shaped to fit around part of the body of the charging component 114 as depicted in FIG. 6A and in FIG. 2. The outer perimeter of the retainer 600 is shaped to rest in the base 602 in such a way as to leave some space under the retainer 600 in which the charging component 114 may fit. As a result, the portion of the charging component 114 not fixed horizontally between the inclusion 601a of the retainer and the outer wall of the base 602 is trapped beneath the retainer 600. FIG. 6B further illustrates how this works by showing the base 602, retainer 600, and charging component 114 assembled together. The charging component 114 is in the location on the base 602 with the lowest floor. As a result, the retainer 600 rests on top of nearly the entire charging component, leaving only its uppermost portion to be surrounded by the inclusion 601a and the wall of the base 602. If the charging component is instead combined with the retainer 600 and base 602 as they are depicted in FIG. 6B, but located on the portion of the base 602 beneath the inclusion 601d, the more elevated floor of the base 602 in that location causes more of the charging component 114 to be at or above the level of the retainer. The inclusion 601d in the retainer at that location is thus larger, and shaped to encompass the outer perimeter of the cross section of the charging component 114 that would be at the same level as the retainer. The portion of the charging component 114 that was lower down would still be trapped beneath the retainer 602, and as a result the charging component 114 would still be held securely in place.

The retainer may be constructed using any material described above for the body 100 in reference to FIG. 1D. The retainer may be constructed using any material described above for the charging component 114 in reference to FIG. 2.

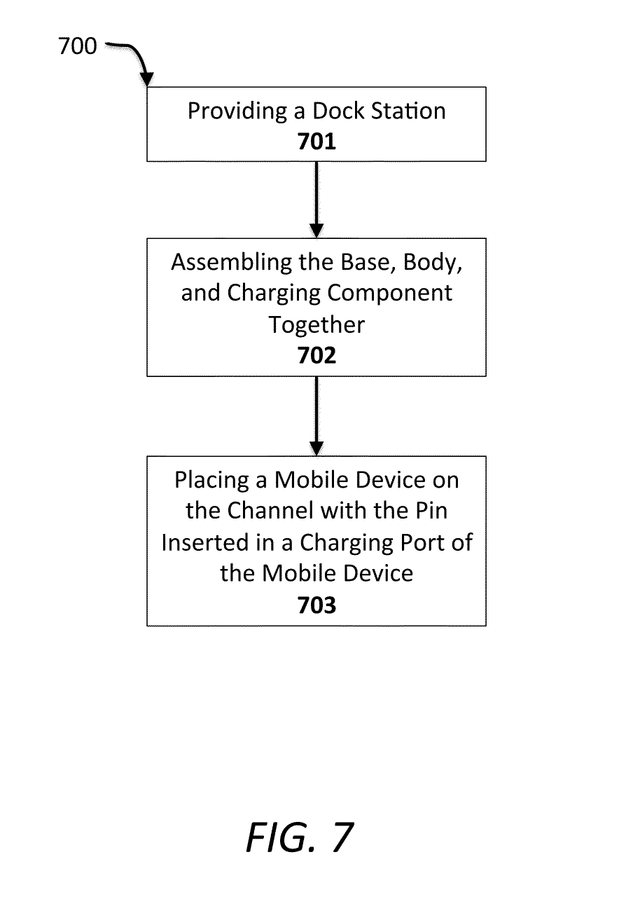

FIG. 7 is a flow chart depicting a method 700 for charging a mobile device. As an overview, the method 700 involves providing a docking station as described above in reference to FIG. 4A (701). The method 700 also involves assembling the base, body, and charging component together (702). The method further involves placing a mobile device on the channel with the pin inserted in a charging port of the mobile device (703).

Now referring to FIG. 7 in further detail, and by reference to FIGS. 3A-4E, the method involves providing a docking station as described above in reference to FIG. 4A (701). As noted above, the docking station has a base 400 that may be rotated to at least two positions relative to the body 100 in which the base 400, body 100, and charging component 114 may be assembled. In some embodiments, the docking station provided also includes a retainer 600 as described above in reference to FIG. 6A.

The method 700 involves assembling the base 400, body 100, and charging component 114 together (702). In some embodiments, the manufacturer initially assembles the docking station prior to shipment to the end user. In some embodiments, the end user performs the initial assembly of the docking station. Where the docking station has a base 400 containing niches 500a-d as provided in FIG. 5A, the charging component is placed in one of the niches 500a-d; the chosen niche 500a-d is the one that in the initially chosen rotational position of the base 400 relative to the body 100 will cause the pin 111 of the charging component 114 to pass through the hole 112 in the channel floor 107 of the body 100 when the base 400, body 100 and charging component 114 are assembled. Equivalently, the base 400 should be rotated after the charging component 114 is placed in the chosen niche 500a-d to effect the assembly that causes the pin 111 to extend through the hole 112. The body 100 is placed over the base 400 with inserted charging component 114 to assemble the docking station. In embodiments of the method 700 in which the provided docking station has a retainer 600 as described above in reference to FIG. 6, the retainer is first placed on top of the charging component 114 in the correct orientation to hold the charging component in place, as described above in reference to FIG. 6. In that case, the body 100 is then placed over the base 400, charging component 114, and retainer 600 to complete the assembly of the docking station. Persons skilled in the art will appreciate that the above-described order of steps in assembling the docking station is provided by way of example only, and that the assembly of the docking station may be performed equally well in a different order. After the docking station is assembled, a mobile device 118 may be placed so as to rest on the channel 107, with the pin 111 inserted in the charging port of the mobile device.

An additional embodiment of the method 700 involves disassembling the docking by separating the body 100, base 400 and charging component from each other, reassembling the docking station by combining the body 100 and base 400 with a second charging component 114 having a second pin 111 suitable for charging a second mobile device 118, and placing the second mobile device 118 on the channel with the second pin 111 inserted in a charging port of the second mobile device 118. As noted above in reference to FIG. 1, the charging component 114 may be exchanged with a second charging component 114 that has a pin 111 suitable for insertion in a different mobile device 117. Thus, as a non-limiting example, if the user was previously using the docking station to charge an iPhone®, and purchased a Samsung® tablet with a distinct charging port, the charging component 114 with a pin 111 suitable for charging the iPhone® could be replaced with a charging component 114 having a pin 111 suitable for the tablet. If the charging cable 200 in the provided docking station is detachable from the charging component 114, as described above, the same charging cable 200 may be detached from the old charging component 114 and used with the new charging component 114. The reassembly of the base 400, body 100 and new charging component 114 may be performed as described above in reference to FIG. 7.

Another embodiment of the method 700 involves disassembling the docking station by separating the body 100, base 400 and charging component 114, rotating the base 400 with respect to the body 100 and charging component 114 to change the height of the charging component 114 within the body 100 when the docking station is assembled, and reassembling the docking station by combining the body 100 and charging component 114 with the rotated base 400. As a non-limiting example, a user may have been using a docking station that has a base as portrayed in FIG. 5A with the charging component resting in the deepest niche 500a with the lowest floor. To make the pin project upwards to a greater extent, the user disassembles the dock, rotating the base 400 so that niche 500d is positioned to support the charging component 114. The user places the charging component 114 in the niche 500d and reassembles the body 100, base 400, and charging component 114. The pin 111 will project farther out of the hole 112 as a result of the new assembly. One non-limiting example of a reason the user might wish to do this is so that the docking station can be used to charge the same mobile device after the user has placed a protective case on it. In an embodiment of the method in which the docking station also includes a retainer 600, the retainer is rotated with the base to hold the charging component in place correctly and the base 400, charging component 114, retainer 600, and body 100 are assembled with the new configuration.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A docking station, comprising:
a body, having (i) a top, an underside, a front end, a back end, and two sides, and (ii) a channel set in the top of the body and extending from one side to the other, and open at both sides, the channel having a floor.

2. A docking station according to claim 1, wherein the body is composed primarily of steel.

3. A docking station according to claim 1, wherein the channel floor extends from the front toward the back at a downward angle with respect to the horizontal.

4. A docking station according to claim 1, wherein the channel has a back wall substantially perpendicular to that floor.

5. A docking station according to claim 4, wherein the channel has no front wall.

6. A docking station according to claim 1, wherein the channel is lined with a soft pad

7. A docking station according to claim 6, wherein the soft pad has a floor located over the floor of the channel, the floor of the soft pad extending from the front toward the back at a downward angle.

8. A docking station according to claim 1, further comprising:
a charging component set within the body and having a circuit that inductively charges a mobile device placed in the channel.

9. A docking station according to claim 1, further comprising a pin extending from the floor of the channel, and substantially perpendicular to that floor, the pin adapted for insertion in a port in a mobile device.

10. A docking station according to claim 9, wherein the pin is not electrical in nature.

11. A docking station according to claim 9, further comprising a hole in the floor of the channel, a hollow chamber beneath the channel and communicating with the hole, and a charging component placed within the hollow chamber, and wherein the pin is attached to the charging component and extends through the hole into the channel.

12. A docking station according to claim 11, wherein the charging component has a perforation, the pin is attached to the charging component by threading an electrical cable that terminates in the pin through the perforation, and the charging component is formed to extend the pin that is so attached through the hole in the channel floor.

13. A docking station according to claim 11, wherein the charging component is composed of flexible material.

14. A docking station according to claim 11, wherein the charging component is connected to a detachable charging cable adapted to insertion into a power source.

15. A docking station according to claim 11, wherein the charging component may be detached from the body and interchanged with another charging component having a differently shaped pin.

16. A docking station according to claim 11, wherein the charging component further comprises a sensor that activates electric circuitry.

17. A docking station according to claim 16, wherein the sensor is taken from a group consisting of a vibration sensor, a capacitance sensor, a noise sensor, an optical sensor, a motion sensor, or an infrared sensor.

18. A docking station according to claim 16, wherein the electrical circuitry activates an indicator light.

19. A docking station according to claim 16, wherein a mobile device is attached to the docking station, and the electrical circuitry communicates with the mobile device.

20. A docking station according to claim 9, further comprising means for simultaneously adjusting the height and forward position of the pin.

21. A docking station according to claim 11, further comprising a base upon which the charging component rests when the base is inserted in the body.

22. A docking station according to claim 21, wherein the body and base are so formed as to permit the base to fit securely in the body in at least two different orientations relative to the body, each orientation resulting in the base supporting the charging component at a different height within the body when the body, charging component, and base are assembled.

23. A docking station according to claim 21, wherein the body and base are so formed as to permit the base to fit securely in the body in at least two different orientations relative to the body, each orientation resulting in the base supporting the charging component at a forward position within the body when the body, charging component, and base are assembled.

24. A docking station according to claim 21, wherein the body and base are so formed as to permit the base to fit securely in the body in at least two different orientations relative to the body, each orientation resulting in the base supporting the charging component at a different height and forward position within the body when the body, charging component, and base are assembled.

25. A docking station according to claim 24, wherein the top surface of the charging component and the underside of the chamber in the body are shaped to engage each other when the charging component is located at least at one height and forward position as supported by the base, and the base is further shaped to admit the charging component in a niche that positions the charging component so as to engage the top surface of the charging component with the underside of the chamber when the body, charging component, and base are assembled.

26. A docking station according to claim 21, wherein the charging component flanges outward towards its bottom, and the base is further shaped to admit the charging component in at least one niche with walls that angle to grip the flanged portion of the charging component when the body, charging component, and base are assembled.

27. A method for charging a mobile device, the method comprising:
providing a docking station according to claim 24;
assembling the base, body, and charging component together; and
placing a mobile device on the channel with the pin inserted in a charging port of the mobile device.

28. A method according to claim 27, further comprising:
disassembling the docking station by separating the body, base and charging component;
reassembling the docking station by combining the body and base with a replacement charging component having a pin suitable for charging a different type of mobile device;
placing the second mobile device on the channel with the second pin inserted in a charging port of the second mobile device.

29. A method according to claim 27, further comprising:
disassembling the docking station by separating the body, base and charging component;
rotating the base with respect to the body and charging component to change the height of the charging component within the body when the docking station is assembled; and
reassembling the docking station by combining the body and charging component with the rotated base.
